(19) United States
(12) Patent Application Publication
(10) Pub. No.: US 2025/0177950 A1
(43) Pub. Date: Jun. 5, 2025

(54) RE-USABLE MOISTURE REMOVING PAD AND METHOD

(71) Applicant: Absorbits, Inc., Wilmington, DE (US)

(72) Inventor: Elliot Harris, Delray Beach, FL (US)

(73) Assignee: Absorbits, Inc., Wilmington, DE (US)

(21) Appl. No.: 18/839,339

(22) PCT Filed: Feb. 16, 2023
(86) PCT No.: PCT/US23/13232

§ 371 Date: Aug. 16, 2024

Related U.S. Application Data
(60) Provisional application No. 63/310,819, filed on Feb. 16, 2022.

(51) Int. Cl. B01J 20/10; B01D 53/04; B01D 53/26; B01J 20/28; B32B 3/02; B32B 3/08; B32B 5/02; B32B 5/26; B32B 7/05; F26B 5/16

(52) U.S. Cl. CPC B01J 20/103; B01D 53/0407; B01D 53/261; B01J 20/2805; B32B 3/02; B32B 3/08; B32B 5/02; B32B 5/26; B32B 7/05; F26B 5/16; B01D 2253/106; B01D 2257/80; B32B 2250/20; B32B 2262/0261; B32B 2262/0276; B32B 2307/726; B32B 2556/00

(57) ABSTRACT

A re-usable moisture removing pad that includes a main pad body with a front layer of a liquid permeable material and a rear layer opposing the front layer, the front and rear layers permanently sealed together around a perimeter to define and encapsulate an internal cavity therein, a structurally unattached periphery, an array of individually sealed silica compartments disposed within the internal cavity and each housing desiccated silica therein, and a hook-and-loop fastener disposed on an outer surface of the rear layer of the main pad body.

### FIELD OF THE INVENTION

The present invention relates generally to moisture removal from electronic devices, firearms, and other moisture-sensitive items, and, more particularly, relates to a re-usable moisture removing pad and method.

### BACKGROUND OF THE INVENTION

It is well known that an electronic device, firearm, and other such moisture-sensitive items that are exposed to moisture can sustain damage to the structure, integrity, functionality, and quality of the components within said device, in particular, to any electronic components therein. Moisture exposure can be quite costly, as it requires replacement of the electronic device, for example, in addition to significant inconvenience for the user as, often, contact information, photographs, text messages, video, and other media stored on the device may not be recoverable. If the data and information is recoverable, it is likely a very expensive and inconvenient process for the user. One study found that 40% of all cell phone insurance claims are the result of water damage. However, most cell phone insurance policies do not cover water damage.

Existing solutions include placing the moisture-filled cell phone into a Ziploc® bag with rice, or silica packets. Although, rice is generally more readily available a typical consumers, it is not very practical because rice does not work as efficiently to draw out moisture as other materials. Further, rice is considered one of the grittiest grains and therefore leaves grain sediment on the phone and within the i/o ports, connectors, and crevices. Therefore, cleaning the cell phone after the process is extremely cumbersome. Most consumers do not have silica packets readily available at their disposal when the emergency situation arises. Accordingly, when the situation arises, the individual's cell phone may not be recoverable by the time the individual orders and receives the silica packets, or attempts to locate a retail establishment that sells silica packets.

Other solutions include plastic, disposable, single-use bags. However, these solutions only provide for a single use and are expensive considering their limited single-use application. They are also a hassle because, after a single use, consumers are required to purchase another single-use bag for another emergency situation, which reduces the likelihood that the bag will be readily available when needed to remove moisture in a subsequent emergency situation.

For example, one known similar reference, Forker, U.S. Patent Application Publication No. 2009/0145783A1 (hereinafter “Forker”), discloses an apparatus and method to remove moisture from a portable electronic device. Forker describes an airtight, sealable container that is divided by an air and moisture permeable barrier into a compartment for a device and a compartment for desiccant silica gel. The silica gel is provided in a separate container and selectively dispensed by the user into the desiccant compartment when desired for use. Unfortunately, the apparatus and method described in Forker has several disadvantages. Due to the disposition of the desiccant compartment adjacent a single side of the device compartment, the removal of fluid from the device is less efficient and therefore requires a longer time to dry out the device. Further, as described above, it very cumbersome to require consumers to purchase additional desiccant in order to be able to use the apparatus again for subsequent emergency situations. Yet, all know methods and apparatuses for utilizing desiccant to remove moisture from electronic devices requires and teaches acquisition of new, unused desiccant for subsequent occasions that require moisture removal. In fact, Forker expressly states that “desiccant has a finite capacity for absorbing moisture, and once desiccant is saturated with moisture it is usually not practical to recycle it.” Accordingly, it is generally known in the desiccant drying arts to avoid re-using desiccant material that has already been used to absorb moisture. Therefore, existing solutions direct consumers to dispose of used desiccant material and acquire new, unused desiccant for subsequent drying occasions. This is a disadvantage of using desiccant to remove moisture from electronic devices. In particular, it is cumbersome and greatly reduces the likelihood that the desiccant material will be readily available when needed to remove moisture in subsequent emergency situations.

Existing solutions also require an airtight sealed container. Forker teaches as much by explaining that an airtight seal “ensures that the desiccant absorbs only water from the portable electronic device, and not from the general environment.” That being said, fasteners for sealing containers in an airtight manner are more complex and expensive to manufacture and design. Other known devices used to remove moisture from electronic devices involve relatively complex and expensive devices typically requiring the use of a vacuum pump.

Therefore, a need exists to overcome the problems with the prior art as discussed above.

### SUMMARY OF THE INVENTION

The invention provides a re-usable moisture removing pad and method, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

With the foregoing and other objects in view, there is provided, in accordance with the invention, a re-usable moisture removing pad with a main pad body having a front layer of a liquid permeable material and a rear layer opposing the front layer, the front and rear layers permanently sealed together around a perimeter to define and encapsulate an internal cavity therein, having a structurally unattached periphery, having an array of individually sealed silica compartments disposed within the internal cavity and each housing desiccated silica therein, and having a hook-and-loop fastener disposed on an outer surface of the rear layer of the main pad body.

In accordance with a further feature of the present invention, the front and rear layers are sealed around a perimeter with stitching located proximal to a bottom edge of the main pad body, an upper edge of the main pad body opposing the bottom edge of the main pad body, a first side edge of the main pad body, and a second side edge of the main pad body opposing the first side edge of the main pad body, wherein the bottom edge, upper edge, and first and second side edges define a continuous periphery of the main pad body.

In accordance with another feature, an embodiment of the present invention includes the pad having an area defined and enclosed by the stitching and completely of the liquid permeable material.

In accordance with a further feature of the present invention, the array of individually sealed silica compartments makes up at least 85% of the area defined and enclosed by the stitching.

In accordance with an additional feature of the present invention, the array of individually sealed silica compartments makes up at least 85% of the total volume of the internal cavity.

In accordance with another feature, an embodiment of the present invention also includes the array of individually sealed silica compartments having at least two rows with horizontally aligned individually sealed silica compartments and at least two columns with vertically aligned individually sealed silica compartments.

In accordance with a further feature of the present invention, each of the horizontally and vertically aligned individually sealed silica compartments are individually sealed by an internal liner of a liquid permeable material and disposed within the internal cavity.

In accordance with an additional feature of the present invention, each of the horizontally and vertically aligned individually sealed silica compartments are maintained in an offset distance of at least 6 mm with the internal liner forming a plurality of flexible joints within the internal cavity.

In accordance with another feature, an embodiment of the present invention also includes an internal liner coupled to an inner surface of at least one of the front layer and rear layer to individually seal each of the individually sealed silica compartments in the array, of a liquid permeable material, and disposed within the internal cavity.

In accordance with an additional feature of the present invention, each of the individually sealed silica compartments in the array are maintained in an offset distance of at least 6 mm with the internal liner forming a plurality of flexible joints within the internal cavity between at least two of the individually sealed silica compartments in the array.

Although the invention is illustrated and described herein as embodied in a re-usable moisture removing pad and method, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward. The figures of the drawings are not drawn to scale.

Before the present invention is disclosed and described, it is to be understood that the terminology used herein is for the purpose of describing particular embodiments only and is not intended to be limiting. The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “providing” is defined herein in its broadest sense, e.g., bringing/coming into physical existence, making available, and/or supplying to someone or something, in whole or in multiple parts at once or over a period of time. Also, for purposes of description herein, the terms “upper”, “lower”, “left,” “rear,” “right,” “front,” “vertical,” “horizontal,” and derivatives thereof relate to the invention as oriented in the figures and is not to be construed as limiting any feature to be a particular orientation, as said orientation may be changed based on the user's perspective of the device. Furthermore, there is no intention to be bound by any expressed or implied theory presented in the preceding technical field, background, brief summary or the following detailed description.

As used herein, the terms “about” or “approximately” apply to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure. In this document, the term “longitudinal” should be understood to mean in a direction corresponding to an elongated direction of the pad, or from the bottom edge to the upper or top edge of the main body of the pad.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and explain various principles and advantages all in accordance with the present invention.

FIG. 1 is a cross-sectional view of a moisture removing pad, illustrating the external, interior, and intermediate layers of the main pad body, in accordance with an exemplary embodiment of the present invention;

FIG. 2 is a front elevational and partially sectional and transparent view of an array of desiccated silica in the moisture removing pad of FIG. 1 in accordance with one embodiment of the present invention;

FIG. 3 is a rear elevational view of the moisture removing pad of FIG. 1 in accordance with one embodiment of the present invention;

FIG. 4 is a process-flow diagram illustrating an exemplary method of removing moisture from a device in accordance with one embodiment of the present invention;

FIG. 5 is a top plan view of a front layer of the moisture removing pad in accordance with one embodiment of the present invention;

FIG. 6 is a top plan view of a rear layer of the moisture removing pad in accordance with one embodiment of the present invention; and

FIG. 7 is a perspective view of a carrying case with two moisture removing pads coupled to a top cover therein in accordance with one embodiment of the present invention.

### DETAILED DESCRIPTION

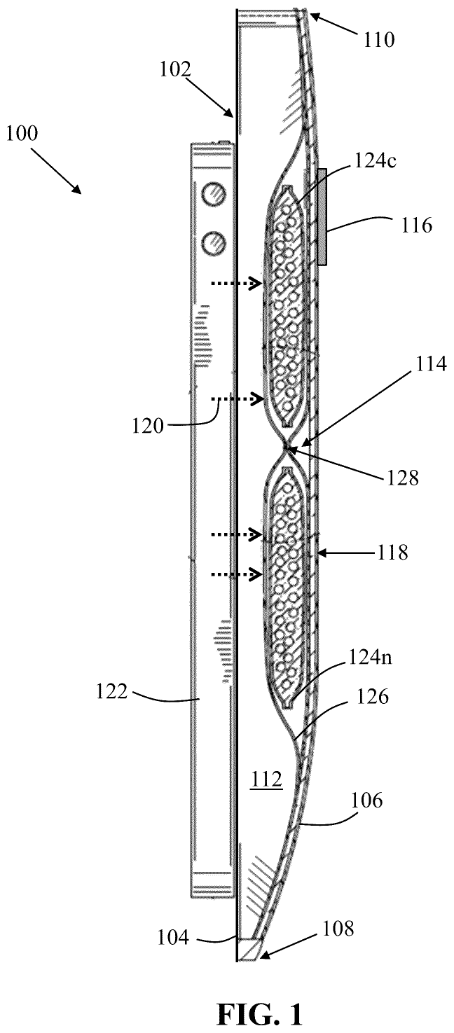

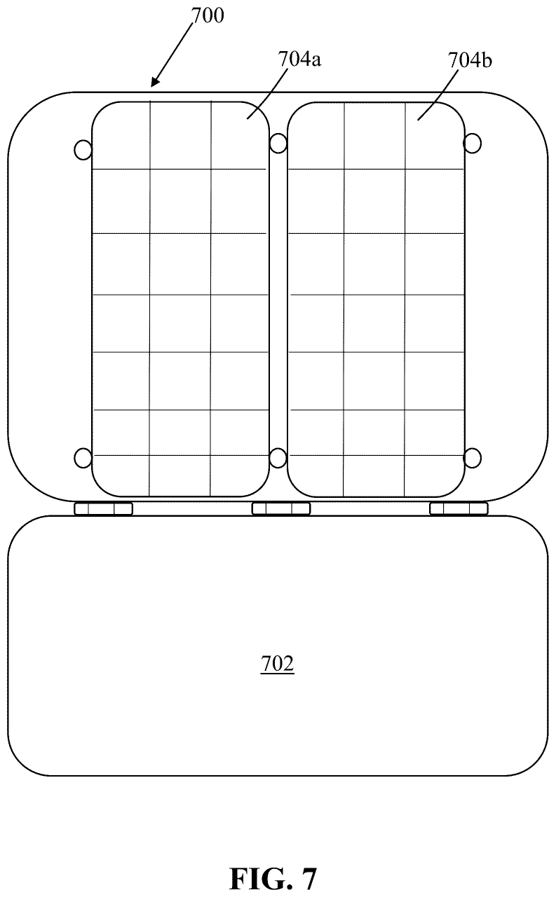

While the specification concludes with claims defining the features of the invention that are regarded as novel, it is believed that the invention will be better understood from a consideration of the following description in conjunction with the drawing figures, in which like reference numerals are carried forward. It is to be understood that the disclosed embodiments are merely exemplary of the invention, which can be embodied in various forms. The present invention, as exemplified in figures, differs in at least one way from the prior known moisture removal devices in that the present invention is intentionally designed without any cavity or aperture for receiving an electronic or other device that needs moisture removed therefrom. Said another way, the moisture removing pad 100 depicted in FIGS. 1-3 lacks a receiving cavity and is formed into a single enclosed and sealed pad with a front layer 104 and a rear layer 106. While FIGS. 1-3 show several advantageous features of the present invention, as will be described below, the invention can be provided in several shapes, sizes, combinations of features and components, and varying numbers and functions of the components. The moisture removing pad 100 depicted in FIG. 1, however, may include a main pad body 102 with overall dimensions (length×width) of inches by 12×12 inches. In other applications, e.g., when the pad(s) 704a-b are utilized with a carrying case 700 operably configured to house and retain, for example, a plurality of firearms and other similar devices in a lower shell 702 of the carrying case 700 that require moisture removal (as depicted in FIG. 7), the pad(s) may be of a rectangular shape and have dimensions of 24×12 inches. Though the main pad body 102 may have alternate dimensions to accommodate alternatively sized and/or shaped devices as well.

The moisture removing pad 100 may be used in connection with a variety of devices (e.g., electronic devices, firearms, boots, etc.) simply by, for example, rolling the device within the main pad body, as opposed to inserting the device within a receiving cavity. Moreover, the present invention comprises a hook-and-loop component that allows any existing case or container (e.g., tool chests, fishing tackle, gun safes, etc.) to be retrofitted with the present invention by attaching the hook-and-loop fastener 116 to the inner surface of the case or container to provide moisture removal.

Beneficially, the present invention is portable and re-usable such that it may be disposed or retrofitted on any variety of cases or containers for a greater breadth and scope of use. Embodiments of the invention provide a main pad body 102 that is operably configured to partially cover a device by placing the device flat on the main pad body, rolling the main pad body, and possibly securing the device therein using a hook-and-loop configuration. An exemplary directional flow of moisture (represented with arrows 120) from the electronic device (e.g., device 122), through an air-permeable inner liner, to the desiccated silica beneficially wicks and removes any excess moisture disposed on, or within, the device 122. Testing has shown that the material utilized for the layers 104, 106 and internal liners produces a structure that transfers virtually all moisture uptake by the pad 100 to desiccated silica (which may include silica gel).

The main pad body 102 includes a front layer 104 and a rear layer 106 opposite the front layer 104. In a preferred embodiment, the front and rear layers 104, 106 are of a nylon fabric or other comparable material composition (e.g., a synthetic thermoplastic linear polyamide or other comparable material) having a liquid permeable property or material. Said another way, the front layer 104 is configured to allow moisture to be transferred or transported therethrough, i.e., it is not non-permeable. Said even further, the front layer 104 and/or rear layer 106 may be of a moisture-wicking and/or moisture-removing properties.

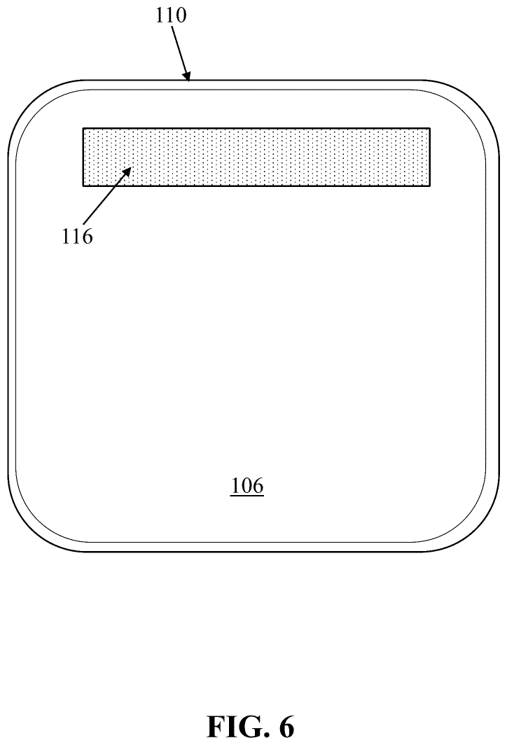

The front and rear layers 104, 106 are permanently sealed together such that they collectively or individually form a uniform and monolithic structure having a bottom edge 108, an upper edge 110 opposite the bottom edge 108, a first side edge 200, and a second side edge 202. Said another way and with reference to FIG. 6, the front and rear layers 104, 106 are sealed around a perimeter (e.g., perimeter) with stitching 602 located proximal (i.e., at or near, within 0.5 inches) to the bottom edge 108 of the main pad body 102, the upper edge 110 of the main pad body 102, the first side edge 200 of the main pad body 102, and the second side edge 202 of the main pad body 102. The bottom edge 108, upper edge 110, and first and second side edges 200, 202 can also be seen defining a continuous periphery of the main pad body 102. The area 606 enclosed by the stitching and/or periphery is preferably of the same liquid permeable property or material. The periphery of the main pad body 102 is “free” or “structurally unattached”, i.e., the outer edges of the main paid body 102 are not permanently (e.g., stitching) or semi-permanently (e.g., with selectively removable fasteners) to any other structure (e.g., another side that forms a pocket).

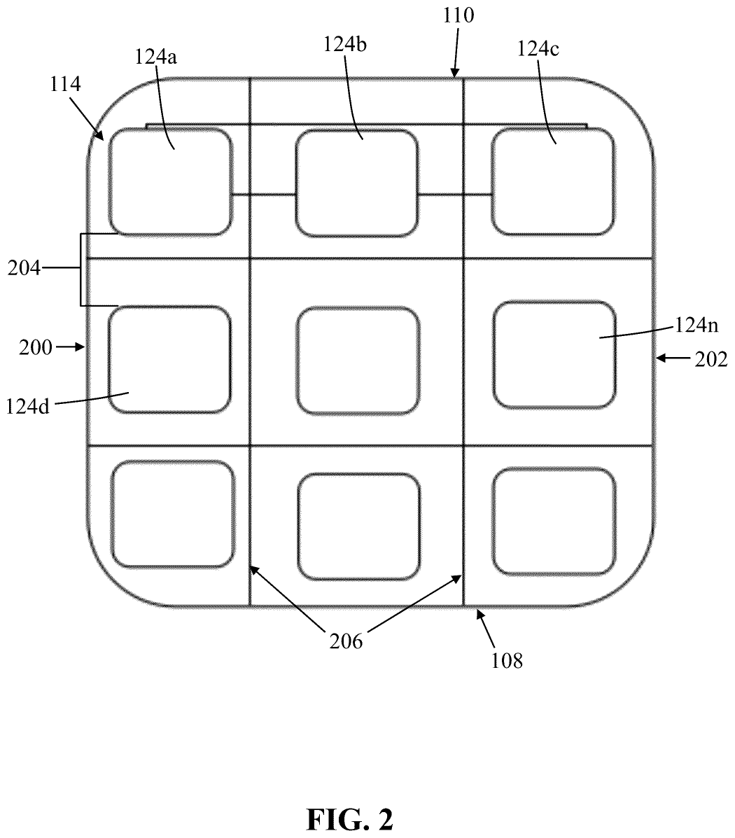

The front and rear layers 104, 106 are permanently sealed together around a perimeter (e.g., perimeter 600) to define and encapsulate an internal cavity 112 therein. With reference to FIGS. 1-2, the internal cavity 112 beneficially has an array 114 of individually sealed silica compartments 124a-n disposed within the internal cavity 112 and each housing desiccated silica therein. Each of the compartments may be permanently sealed therein on all sides. As used herein, the term “permanently sealed” is intended to indicate a joining of at least two things together so as to prevent them from coming apart during normal use (e.g., stitching, a permanent adhesive material, etc.), wherein any coming apart of the at least two things constitutes a destruction of the pad 100 for its normal, intended operational use.

The front and rear layers 104, 106 may be considered to be permanently sealed together along an entire outer perimeter, sometimes on the edges or sides 108, 110, 200, 202, respectively, thereof, so as to permanently seal the array 114 of desiccated silica 114 therein. In other words, the permanent seal extends continuously along the entire outer perimeter so as to prevent access into and a removal of the array of desiccated silica 114 from within the internal cavity 112. This permanently sealed feature underlies the reusability of the inventive moisture removal pad 100 of the present invention that distinguishes it from existing moisture removal systems. Unexpectedly, applicants of the present invention have discovered that desiccated silica may be reused to remove moisture from electronic devices on multiple separate occasions.

In the exemplary embodiment depicted in FIG. 2, the array of desiccated silica 114 are comprised of rectangular-shaped compartments 124a-n (wherein “n” refers to any number greater than one) housing desiccated silica. In an alternative embodiment, the compartments 124a-n may be other shapes, such as a circle, square, or other polygon-shape. Preferably, the compartments 124a-n are encapsulated by a material that also enables liquid permeability. The array of individually sealed silica compartments 114 beneficially make up at least 85%, but preferably 95%, of the internal cavity 112 to maximize exposure to the desiccated silica. Said another way, the array of individually sealed silica compartments 124a-n makes up at least 85% of the area 606 defined and enclosed by the stitching and completely of the liquid permeable material, thereby effectively removing moisture from a device on or enclosed by the pad 100. The compartments 124a-n may also be considered “embedded”, i.e., entirely surrounded and enclosed within the main pad body 102 so as be neither accessible nor visible from an external environment. This provides a sleek design that permits the moisture removing pad 100 to be usable on an everyday basis as an everyday carrying case, which, advantageously, increases the probability that the moisture removing pad 100 will be immediately available to the user for its intended operational use as a moisture removing apparatus when the emergency situation arises, the emergency situation being that the user's device (e.g., electronic device, firearm, etc.) is exposed to moisture.

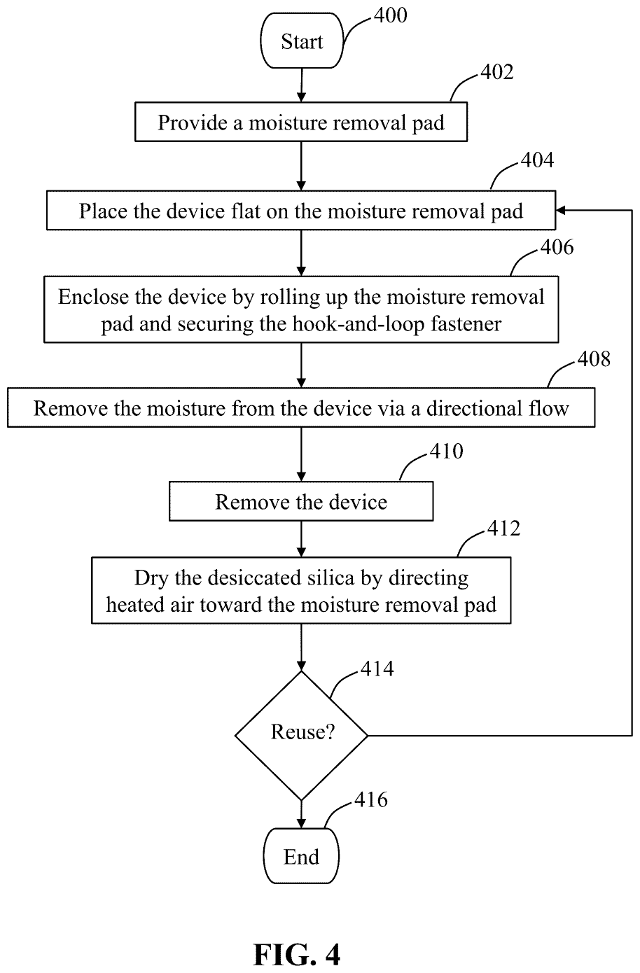

In one embodiment, the compartments 124a-n may be disposed so as to be vertically aligned with one another. Said another way, the array 114 of individually sealed silica compartments 124a-n are made from at least two rows with horizontally aligned individually sealed silica compartments and at least two columns with vertically aligned individually sealed silica compartments. This feature is exemplified best in FIGS. 1-2 and preferably the pad 100 includes three rows and three columns, but this may be varied depending on the design application. Each of the horizontally and vertically aligned individually sealed silica compartments 124a-n in the array 114 may also be individually sealed by an internal liner 126 of a liquid permeable material to keep the sealed silica compartments 124a-n in a stable position for repeated use. In an alternative embodiment, the compartments 124a-n may be disposed so as to be aligned with one another in other configurations relative to one another, such as, for example, a horizontal alignment. Advantageously, by segmenting the sealed silica compartments 124a-n into separate independent sub-compartments, the desiccated silica may be dried more quickly after one use so that the pad 100 may be subsequently reused, as will be described in more detail herein below with reference to the flow chart depicted in FIG. 4.

The internal liner 126 preferably extends substantially the entire inner diameter or length and width (i.e., +/−95%) of the internal channel 114. Each of the horizontally and vertically aligned individually sealed silica compartments 124a-n are maintained in an offset distance 204 of at least 6 mm with the internal liner 126 forming a plurality of flexible joint (e.g., joint 128) within the internal cavity 112, thereby enabling the pad to flex and conform to different sizes and shapes of devices desirous to remove moisture from. Said another way, each of the individually sealed silica compartments 124a-n in the array are maintained in an offset distance (e.g., distance 204) of at least 6 mm and no more than 30 mm with the internal liner 126 forming a plurality of flexible joints within the internal cavity 112 between at least two of the individually sealed silica compartments 124a-n in the array 114. Preferably, the individually sealed silica compartments 124a-n are offset a uniform distance from one another along a row or column to ensure flexibility of the pad body 102. Said another way, each of the joints may be parallel to one another to ensure flexibility of the pad body 102.

In one embodiment, the rear layer 106 of the main pad body 102 may be considered a mirror image of the front layer 104 with identical features and layers, except disposed opposite the front layer 104. Each of the compartments 124a-n may be considered to be permanently sealed along an entire outer perimeter of the compartment thereof so as to permanently seal the desiccated silica therein. In other words, the permanent seal extends continuously along the entire outer perimeter to prevent access into and a removal of desiccated silica from within the compartments.

The compartments 124a-n may be disposed to be vertically aligned with one another. In an alternative embodiment, the compartments 124a-n may be disposed so as to be aligned with one another in other configurations relative to one another, such as, for example, a horizontal alignment. Advantageously, by segmenting the desiccated silica into separate compartments, the desiccated silica may be dried more quickly after one use so that the pad 100 may be subsequently reused, as will be described in more detail herein below with reference to the flow chart depicted in FIG. 4. In one embodiment, the compartments 124a-n may be formed by stitching compartment panels to the inner liner 126.

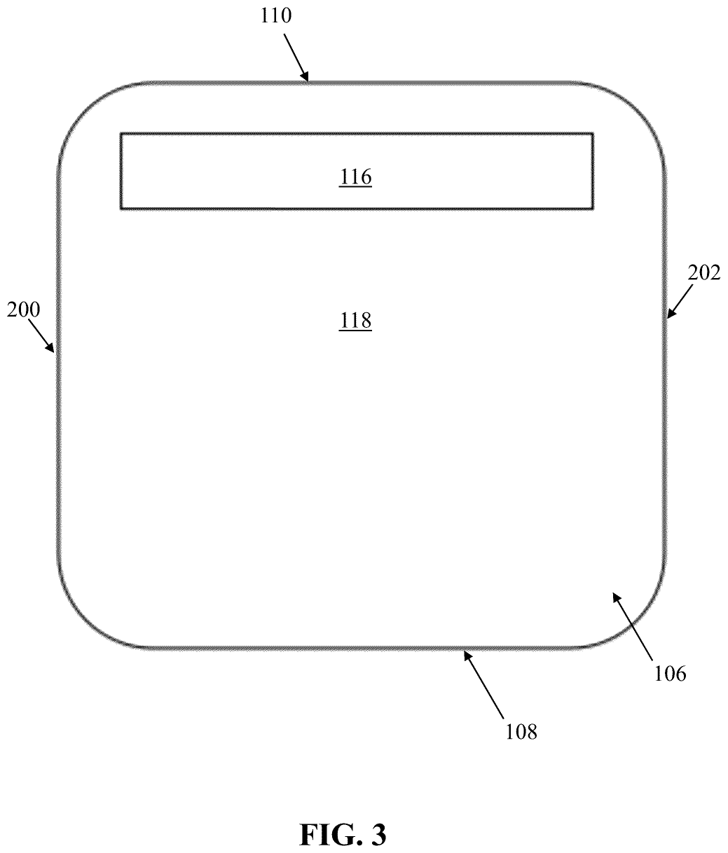

Referring now to FIG. 3, the side edges 200, 202 may be considered opposing side edges 200, 202. The side edges 200, 202 may be oriented parallel within one another and oriented perpendicular to the bottom edge 108. In one embodiment, the front and rear layers 104, 106 are stitched together at the side edges 200, 202. In yet another embodiment, the front and rear layers 104, 106 are formed as a continuous panel that is stitched together at the side edges 200, 202 to form the main pad body 102 and simultaneously folded up to be continuous at the bottom edge 108 and at the upper edge 110 of the main pad body 102. In yet other embodiments, the front and rear layers 104, 106, the side edges 200, 202, and the bottom and upper edges 108, 110 may be provided in other orientations and configurations.

Beneficially, the main pad body 102 is operably configured to enclose or surround a device (e.g., a phone, firearm, etc.) by placing the device flat on an outer surface of the front layer 104 of the main pad body 102 and rolling up the main pad body 102 around the device until the main pad body 102 forms a retention channel around the device, i.e., the device is disposed within the retention channel after folded. The main pad body 102 may be secured in place around the device in a non-airtight sealable manner via a hook-and-loop configuration 116 disposed on an outer surface 118 of the rear layer 106 of the main pad body 102. In other embodiment, the hook-and-loop fastener 116 is disposed on the outer surface of the rear layer 106 of the main pad body 102 and is used to attach the pad body 102 in a flat or planar configuration on to an external structure (where the device is placed or forced up against).

When folded, the retention channel is sized to receive a standard-sized smart phone therein. Standard-sized smart phones have dimension ranges that are about 5-6 inches in length, 3-3.5 inches in width, and 0.3-0.4 inches in thickness. In one embodiment, the retention channel may be sized to receive the standard-sized smart phone therein within a snug fit. As used herein, the term “snug fit” is intended to indicate a tight fit for the standard-sized smart phone when it is disposed within the retention channel. Advantageously, the snug fit feature provides more efficient and quick removal of moisture from the electronic device disposed within the snug fit retention channel. For example, as can be seen in FIG. 1 (which depicts the device lying flat on the main pad body 102 as opposed to being disposed within the retention channel), the electronic device is immediately adjacent to the front layer 104, and, more particularly, almost immediately adjacent (within approximately 25 mm) the array of desiccated silica 114 within the respective compartments, with the exception of one or more relatively thin permeable inner layers 126 disposed between the device and the desiccated silica 114. Also, with the snug fit sizing of the retention channel, fluid moisture is less likely to travel into the retention channel from an external environment, undesirably saturating the desiccated silica, which is more preferably reserved for absorbing moisture from the device. Unlike known prior art, the present invention allows for a greater variety of devices, e.g., different shapes, forms, sizes, etc., to be used with the moisture removing pad 100. Although the moisture removing pad 100 may be used by rolling the main pad body 102 to form the retention channel, with the device disposed therein, the moisture removing pad 100 may also be used while lying and remaining flat on a substantially planar surface.

The front layer 104 may be a fluid-permeable material operably configured to be disposed between the device and the desiccated silica array 114 to permit the flow of moisture from the device 122 disposed to the desiccated silica 114. In one embodiment, the air-permeable inner liner 126 may be a continuous liner layer that extends continuously within the internal channel 112. In another embodiment, the air-permeable inner liner 126 may be a discontinuous liner layer, yet still overlapping with the desiccated silica-filled compartments 124a-n so as to permit the flow of moisture therethrough from the electronic device.

In one embodiment, the air-permeable and/or liquid-permeable inner liner 126 may be made of a polyester fabric, such as, for example, a peach skin polyester lining. In a further embodiment, the permeable inner liner 126 may be made of a nylon material. In yet other embodiments, the permeable inner liner 126 may be made of other air-permeable and/or liquid-permeable materials and fabrics. In another embodiment, the permeable inner liner 126 allows moisture to pass through but does not itself absorb the moisture. In other embodiments, the air-permeable inner liner may possess other properties.

In one embodiment, the layer(s) 104, 106 may be of a nonwoven fabric. A nonwoven fabric is a fabric-like material that is typically made of long fibers, bonded together by chemical, mechanical, heat or solvent treatment, rather than by being woven together. In a further embodiment, the non-woven fabric may be known nonwoven fabrics, such as, for example, felt or a nonwoven polymer-based composite. In other embodiments, the exterior layer may be made of other fabrics and materials.

In one embodiment, the main pad body 102 may also include a cushion layer, such as a sponge or soft foam material. The cushion layer may be disposed between one of the layer(s), preferably the front layer 104, and the desiccated silica-filled compartments 124a-n. The cushion layer may provide an additional moisture barrier to keep moisture from the external environment from reaching the desiccated silica unless depressed (in which case it may become more porous) and may also provide a soft protective barrier to prevent damage to the electronic device disposed within the moisture removing pad 100.

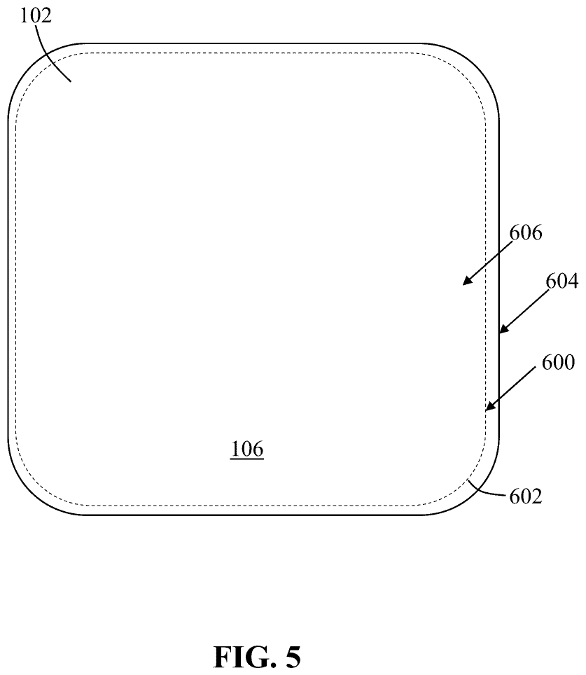

The inventive process will now be described with reference to the flow chart depicted in FIG. 4 in conjunction with FIGS. 1-3 and FIGS. 5-7. Although FIG. 4 shows a specific order of executing the process steps, the order of executing the steps may be changed relative to the order shown in certain embodiments. Also, two or more blocks shown in succession may be executed concurrently or with partial concurrence in some embodiments. Certain steps may also be omitted in FIG. 4 for the sake of brevity.

The process may begin at stop 400 and may immediately proceed to step 402, where the moisture removing pad 100 is provided. In step 404, the user may place the device flat on the main pad body 102. In step 406, the user may enclose the device in the non-airtight sealable manner within the moisture removing pad 100 by rolling or sectionally folding the main pad body 102 to form a retention channel, the device disposed within the retention channel. The main pad body 102 may be secured in place around the device using the hook-and-loop configuration 116 disposed on the outer surface of the rear layer 106 of the main pad body 102. In a preferred embodiment, the hook-and-loop configuration 116 is disposed proximal to the upper edge 110 of the main pad body 102, wherein “proximal to” is defined as at or near, i.e., within 5% to 30% of the upper edge 110, to the upper edge 110. Beneficially, the hook-and-loop coupling configuration 116 may be used to secure the main pad body 102 in place around the device (i.e., forming a retention channel, with the device disposed therein) and to secure the moisture removing pad 100 onto a surface, e.g., onto the interior wall of a safe; onto the interior wall of a tool chest; onto the interior wall of a fishing tackle box, etc.

In step 408, moisture is automatically removed from the device in the bi-directional flow of moisture from the device to the desiccated silica 114, as discussed herein above. The user may wait for several hours to permit the moisture to be completely removed.

In step 412, after the moisture has been removed in step 410, the user may actively dry the desiccated silica 114. In one embodiment, the user may dry the desiccated silica 114 by directing heated air from an electronic drying device, such as a hair dryer, toward the moisture removing pad 100. Specially, the heated air may cause the moisture within the desiccated silica 114 to evaporate. In one embodiment, the main pad body 102 may be laid flat during step 412 so as to permit the moisture vapors to escape into the external environment. The heated air may be directed toward the desiccated silica 114 for many minutes, until the desiccated silica 114 is dry.

In step 414, the user queries whether the moisture removing pad 100 is desired by the user to be reused to remove moisture from a device, either the same device or another. If the answer is “yes,” e.g., the device gets wet again, the process moves to step 404 and repeats, i.e., the pad 100 may be re-usable. If the answer is “no,” e.g., the device does not become wet again, the process ends at step 416.

Various modifications and additions can be made to the exemplary embodiments discussed without departing from the scope of the present disclosure. For example, while the embodiments described above refer to particular features, the scope of this disclosure also includes embodiments having different combinations of features and embodiments that do not include all of the above-described features.

What is claimed is:

1. A re-usable moisture removing pad comprising:
a main pad body with:
a front layer of a liquid permeable material and a rear layer opposing the front layer, the front and rear layers permanently sealed together around an entire perimeter to define and encapsulate an internal cavity therein;
a structurally unattached periphery;
an array of individually sealed silica compartments each formed from a liquid permeable material panels unattached to the front and rear layers, each flanked by the front and rear layers, disposed within the internal cavity, and each housing desiccated silica therein; and
a hook-and-loop fastener disposed on an outer surface of the rear layer of the main pad body.

2. The re-usable moisture removing pad in accordance with claim 1, wherein:
the front and rear layers are sealed around a perimeter with stitching located proximal to a bottom edge of the main pad body, an upper edge of the main pad body opposing the bottom edge of the main pad body, a first side edge of the main pad body, and a second side edge of the main pad body opposing the first side edge of the main pad body, the bottom edge, upper edge, and first and second side edges defining a continuous periphery of the main pad body.

3. The re-usable moisture removing pad according to claim 2, wherein the pad further comprises:
an area defined and enclosed by the stitching and completely of the liquid permeable material.

4. The re-usable moisture removing pad according to claim 3, wherein the array of individually sealed silica compartments makes up at least 85% of the area defined and enclosed by the stitching.

5. The re-usable moisture removing pad according to claim 1, wherein the array of individually sealed silica compartments makes up at least 85% of the total volume of the internal cavity.

6. The re-usable moisture removing pad according to claim 1, wherein the array of individually sealed silica compartments further comprises:
at least two rows with horizontally aligned individually sealed silica compartments and at least two columns with vertically aligned individually sealed silica compartments.

7. The re-usable moisture removing pad according to claim 6, wherein each of the horizontally and vertically aligned individually sealed silica compartments are individually sealed by an internal liner of a liquid permeable material and disposed within the internal cavity.

8. The re-usable moisture removing pad according to claim 7, wherein each of the horizontally and vertically aligned individually sealed silica compartments are maintained in an offset distance of at least 6 mm with the internal liner forming a plurality of flexible joints within the internal cavity.

9. The re-usable moisture removing pad according to claim 1, further comprising:
an internal liner coupled to an inner surface of at least one of the front layer and rear layer to individually seal each of the individually sealed silica compartments in the array, of a liquid permeable material, and disposed within the internal cavity.

10. The re-usable moisture removing pad according to claim 9, wherein each of the individually sealed silica compartments in the array are maintained in an offset distance of at least 6 mm with the internal liner forming a plurality of flexible joints within the internal cavity between at least two of the individually sealed silica compartments in the array.
